(19) United States
(12) Patent Application Publication
(10) Pub. No.: US 2004/0090204 A1
(43) Pub. Date: May 13, 2004

(54) Electric motor driven engine accessories

(75) Inventor: Ray M. McGinley, Fountain Hills, AZ (US)

Correspondence Address: Honeywell International, Inc., Law Dept. AB2, P.O. Box 2245, Morristown, NJ, 07962-9806, US

(73) Assignee: Honeywell International Inc., Morristown, NJ (US)

(21) Appl. No.: 10/293,186

(22) Filed: Nov. 12, 2002

(51) Int. Cl. H02P 1/54

(52) U.S. Cl. 318/767; 318/34

(57) ABSTRACT

A permanent magnet generator generates a variable voltage/variable frequency electric current to power electric induction motors. These motors, in turn, may be used to power electric motor driven engine accessories. The permanent magnet generator is powered directly by a gas turbine engine. A ratio of the variable voltage to the variable frequency remains substantially constant throughout all operating conditions of the gas turbine engine. The relationship of engine speed to accessory speed will remain fixed as the engine speed varies, similarly to the relationship realized when a gearbox was employed. The resulting power system is useful in supplying power from a gas turbine engine to various induction motor driven accessories in aircraft, ground based vehicles, and the like, particularly when the engine has no gearbox. The power system requires no motor controllers and may be used to supply any induction motor driven equipment, including equipment which is not traditionally engine or gearbox mounted.

### BACKGROUND OF THE INVENTION

The present invention generally relates to methods and an apparatus for driving electric motors, particularly, electric motor driven engine accessories such as fuel, lubrication and air pumps. More specifically, the present invention relates to methods and an apparatus for driving engine accessories directly from a shaft mounted electrical generator in lieu of a gearbox.

Gas turbine engines provide propulsion and auxiliary power services (electric, pneumatic, and hydraulic) for aircraft and certain ground-based vehicles. Typically, gearboxes transmit shaft power of the gas turbines to electrical generators, hydraulic pumps, fuel pumps, air pumps, and other auxiliary devices.

Gearboxes are heavy and noisy. They also require lubrication and all of the maintenance demands of a lubrication system. Additionally, gearboxes can be unreliable.

These problems are compounded for gas turbine engines that drive multiple auxiliary devices. Additional gears are needed for driving the additional devices, thus adding weight, noise and unreliability. Engines with shaft mounted, direct drive electrical generators are being designed without a gearbox. Engine accessories that were previously driven by the gearbox now require a new drive method.

U.S. Pat. No. 5,903,115 discloses an auxiliary system including a plurality of ac motor-driven devices that are driven without a gearbox coupled to a turbine engine. This conventional system, however, is drawn to a fixed frequency generator with regulated output voltage driving a fixed speed motor. Selection of the number of poles on the ac motors and the generator provides the equivalent of a gear ratio. The rated speed of the motors may be changed, however, to do so, the number of poles on the generator or the number of poles on the motor must be changed. This system is best employed with engines operating over a narrow speed range, since commonplace induction motors are not suited for power supplied from a fixed (regulated) voltage, variable frequency generator. Furthermore, this system is apparently limited to providing power to motor-driven devices only after the gas turbine engine has been accelerated to governed speed.

As can be seen, there is a need for an improved auxiliary system for driving engine accessories wherein the auxiliary system is simple, low cost, easy to maintain, and usable on a broader range of applications.

### SUMMARY OF THE INVENTION

In one aspect of the present invention, a method for powering an electric induction motor comprises rotating an engine shaft connected to a permanent magnet generator; generating a variable voltage/variable frequency electric current with the permanent magnet generator; and powering electric induction motor driven engine accessories with the electric current, wherein a ratio of the variable voltage to said variable frequency remains substantially constant.

In another aspect of the present invention, a method for powering an electric induction motor comprises rotating a shaft with a gas turbine engine, the shaft being formed integrally with an input shaft of a permanent magnet generator; generating a variable voltage/variable frequency electric current with the permanent magnet generator; energizing a variable voltage/variable frequency bus with the electric current; electrically connecting the variable voltage/variable frequency bus with the electric induction motor driven engine accessories; and powering the electric induction motor driven engine accessories with the electric current, wherein a ratio of the variable voltage to the variable frequency remains substantially constant.

In a further aspect of the present invention, a method for powering at least one electric induction motor on an aircraft comprises rotating a shaft with a gas turbine engine, the shaft being formed integrally with an input shaft of a permanent magnet generator; generating an variable voltage/variable frequency electric current with the permanent magnet generator; energizing a variable voltage/variable frequency bus with the electric current; electrically connecting the variable voltage/variable frequency bus with at least one electric induction motor; and powering at least one electric induction motor driven engine accessory with the electric induction motor, wherein a ratio of the variable voltage to the variable frequency remains substantially constant.

In still another aspect of the present invention, a system for driving an electric induction motor comprises a permanent magnet generator having a rotor structure and armature windings, the rotor structure being turned by an input shaft; a gas turbine engine turning a shaft, the shaft integrally connected to the input shaft; the permanent magnet generator generating a variable voltage/variable frequency electric current; a ratio of the variable voltage to the variable frequency being substantially constant; and the variable voltage/variable frequency electric current providing power for the electric induction motor driven engine accessories.

In still a further aspect of the present invention, a system for driving an electric induction motor comprises a permanent magnet generator having a rotor structure and armature windings, the rotor structure being turned by an input shaft; a gas turbine engine turning a shaft, the shaft integrally connected to the input shaft; the permanent magnet generator generating a variable voltage/variable frequency electric current; a ratio of the variable voltage to the variable frequency being substantially constant; a variable voltage/variable frequency bus energized with the electric current; and at least one set of electrical conductors electrically connecting the variable voltage/variable frequency bus with the electric induction motor driven accessories, thereby providing power for the electric motor driven engine accessories.

In yet another aspect of the present invention, a system for driving electric induction motor driven accessories comprises rotating means for rotating an input shaft of a permanent magnetic generator; generating means for generating three-phase variable voltage/variable frequency ac electric current wherein a ratio of the variable voltage to said variable frequency is substantially constant; powering means for supplying the electric current from the generating means to the electric induction motor driven accessories.

These and other features, aspects and advantages of the present invention will become better understood with reference to the following drawings, description and claims.

### BRIEF DESCRIPTION OF THE DRAWINGS

FIG. 1 is a schematic drawing showing an electrical generating system driving electric motor engine accessories according to one embodiment of the present invention;

FIG. 2 is a partially cut-away schematic drawing showing a permanent magnetic generator used in the embodiment of FIG. 1;

FIG. 3 is a graph showing the substantially constant ratio between engine frequency and generator output voltage in the system of FIG. 1; and

FIG. 4 is a partially cut-away schematic drawing showing a dual permanent magnetic generator used in the embodiment of FIG. 1.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a method and an apparatus for driving engine accessories such as fuel, lubrication and air pumps. More specifically, the present invention provides a method and an apparatus for driving engine accessories with shaft mounted, direct driven electrical generators in lieu of a gearbox. The method and apparatus for driving engine accessories of the present invention are useful in driving fuel pumps, lubrication pumps, and air pumps in aircraft and ground-based vehicles.

Unlike conventionally driven engine accessories, the method and apparatus of the present invention does not require a gearbox to drive a simple variable speed-driven accessory, such as a fuel pump, a lubrication pump, and an air pump. Furthermore, unlike conventionally driven engine accessories, the need for a separate motor controller is avoided in the electric motor driven engine accessory system of the present invention.

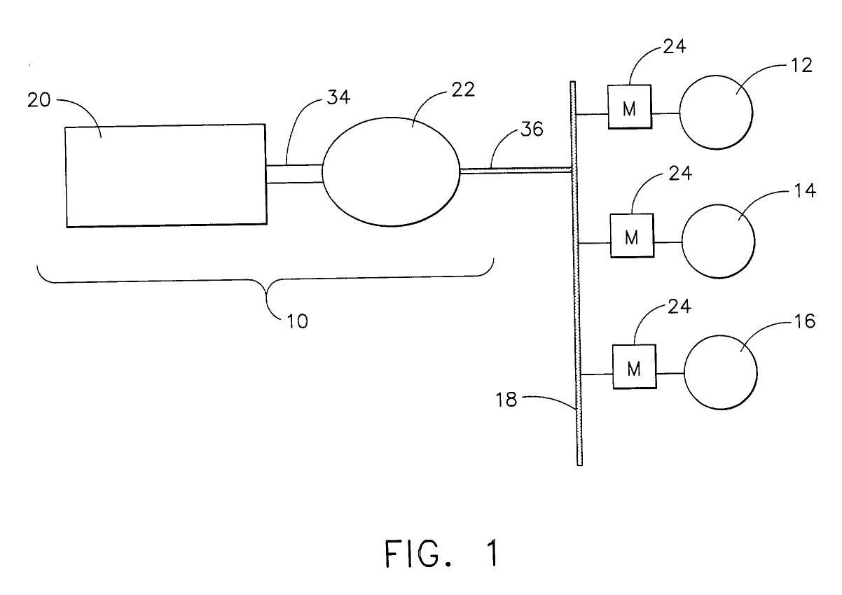

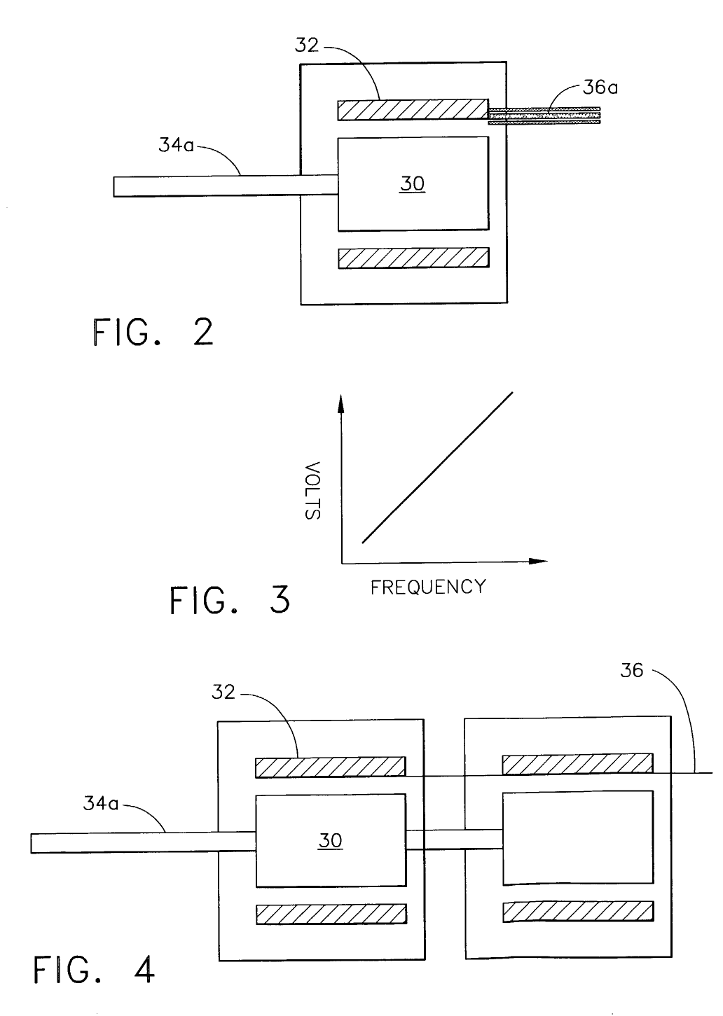

Referring to FIGS. 1 and 2, there is shown an electrical generating system 10 for driving electric induction motor engine accessories such as a fuel pump 12, a lube pump 14, and an air pump 16. Electrical generating system 10 may include a gas turbine engine driving a permanent magnet generator (PMG) 22. The PMG 22 may have a rotor structure 30 driven by a shaft 34. Shaft 34 is considered an engine output shaft 34 when shaft 34 is rotated by gas turbine engine 20. Engine output shaft 34 may directly connect gas turbine engine 20 with PMG 22, thereby making engine output shaft 34 of gas turbine engine 20 integral with an input shaft 34a of PMG 22.

PMG 22 may include a set of three-phase armature windings 32 developing three-phase AC power. The AC power may be delivered to a bus 18 via a set of electrical conductors 36. In a three-phase system, electrical conductors 36 may include three conductors 36a. An isolator 38 may be present between bus 18 and any of the electric induction motor engine accessories. Isolator 38 includes a plurality of switches coupling a phase winding of its corresponding electric induction motor driven accessory to an armature winding 32 of PMG 22.

Referring also now to FIG. 3, there is shown a graph showing the relatively constant ratio of voltage to frequency output by PMG 22. PMG 22 may provide a variable frequency/variable voltage output to bus 18, which will be approximately proportional to the rotational speed of gas turbine engine 20. The ratio of voltage to frequency generated by PMG 22 may remain approximately constant at the operating rotational speeds.

Each of fuel pump 12, lube pump 14 and air pump 16 will be mechanically connected to an induction motor 24 to drive the pumps. The induction motors 24 may be powered via bus 18. As the gas turbine engine 20 accelerates, the voltage and frequency output of PMG 22 will increase, and the induction motor and accessory pump speed will increase.

Referring now to FIG. 4, there is shown an electrical generating system having two generators. The present invention is not meant to be limited to using a single engine generator as described above. An electrical system may be constructed with two (or more) generators in which one is used to supply induction motor driven equipment and the other (non-PMG) generator is designed to supply equipment with fixed voltage power. The present invention discloses powering induction motors to drive fuel pumps, lube pumps, and air pumps. The present invention may also be applied to drive any electrically powered system capable of running off an induction motor with a constant voltage to frequency ratio. This includes equipment or systems which are not usually driven by engine gearboxes, but which could be effectively driven by an induction motor powered directly from a PMG.

It should be understood, of course, that the foregoing relates to preferred embodiments of the invention and that modifications may be made without departing from the spirit and scope of the invention as set forth in the following claims.

We claim:

1. A method for powering an electric induction motor comprising:
rotating a shaft connected to a permanent magnet generator;
generating a variable voltage/variable frequency electric current with said permanent magnet generator; and
powering said electric induction motor with said electric current, wherein a ratio of said variable voltage to said variable frequency remains substantially constant.

2. The method for powering an electric induction motor according to claim 1, further comprising driving an electric induction motor driven engine accessory with said electric induction motor.

3. The method for powering an electric induction motor according to claim 1, wherein said shaft is rotated through the power of a gas turbine engine.

4. The method for powering an electric induction motor according to claim 1, wherein said shaft is integrally formed with an input shaft of said permanent magnet generator.

5. The method for powering an electric induction motor according to claim 1, further comprising energizing a variable voltage/variable frequency bus with said electric current.

6. The method for powering an electric induction motor according to claim 5, further comprising electrically connecting said variable voltage/variable frequency bus with said electric motor.

7. The method for powering an electric induction motor according to claim 2, wherein said electric motor driven engine accessory is selected from the group consisting of a fuel pump, a lube pump, and an air pump.

8. A method for powering an electric induction motor, comprising:
rotating a shaft with a gas turbine engine, said shaft being formed integrally with an input shaft of a permanent magnet generator;
generating a variable voltage/variable frequency electric current with said permanent magnet generator;
energizing a variable voltage/variable frequency bus with said electric current;
electrically connecting said variable voltage/variable frequency bus with said electric induction motor; and
powering said electric induction motor with said electric current, wherein a ratio of said variable voltage to said variable frequency remains substantially constant.

9. The method for power an electric induction motor according to claim 8, further comprising driving an electric induction motor driven engine accessory with said electric induction motor.

10. The method for powering an electric induction motor according to claim 9, wherein said electric induction motor driven engine accessory is selected from the group consisting of a fuel pump, a lube pump, and an air pump.

11. A method for powering at least one electric induction motor on an aircraft, comprising:
rotating a shaft with a gas turbine engine, said shaft being formed integrally with an input shaft of a permanent magnet generator;
generating a variable voltage/variable frequency electric current with said permanent magnet generator;
energizing a variable voltage/variable frequency bus with said electric current;
electrically connecting said variable voltage/variable frequency bus with said at least one electric induction motor; and
powering at least one electric induction motor driven engine accessory with said electric induction motor, wherein a ratio of said variable voltage to said variable frequency remains substantially constant.

12. The method for powering at least one electric induction motor on an aircraft according to claim 11, wherein:
said at least one induction motor includes at least two induction motors; and
said at least one electric induction motor driven accessory includes at least two electric induction motor driven accessories, each one being driven by one of said at least two induction motors.

13. The method for powering at least one electric induction motor on an aircraft according to claim 12, wherein said at least two electric motor driven engine accessories include at least one of a fuel pump, lube pump, and air pump.

14. A system for driving an electric induction motor comprising:
a permanent magnet generator having a rotor structure and armature windings, said rotor structure being turned by an input shaft;
a gas turbine engine turning a engine output shaft, said engine output shaft integrally connected to said input shaft;
said permanent magnet generator generating a variable voltage/variable frequency electric current;
a ratio of said variable voltage to said variable frequency being substantially constant; and
said variable voltage/variable frequency electric current providing power for said electric induction motor.

15. The system for driving an electric induction motor according to claim 14, further comprising an electric induction motor driven engine accessory driven by said electric induction motor.

16. The system for driving an electric induction motor according to claim 14, further comprising a variable voltage/variable frequency bus being energized with said electric current.

17. The system for driving an electric induction motor according to claim 16, further comprising at least one set of electrical conductors electrically connecting said variable voltage/variable frequency bus with said electric motor driven engine accessories.

18. The system for driving an electric induction motor according to claim 14, wherein said electric motor driven engine accessories include at least one of a fuel pump, a lube pump, and an air pump.

19. A system for driving an electric induction motor comprising:
a permanent magnet generator having a rotor structure and armature windings, said rotor structure being turned by an input shaft;
a gas turbine engine turning an engine output shaft, said engine output shaft integrally connected to said input shaft;
said permanent magnet generator generating a variable voltage/variable frequency electric current;
a ratio of said variable voltage to said variable frequency being substantially constant;
a variable voltage/variable frequency bus energized with said electric current; and
at least one set of electrical conductors electrically connecting said variable voltage/variable frequency bus with said electric induction motor, thereby providing power for said electric induction motor.

20. The system for driving an electric induction motor according to claim 19, further comprising an electric induction motor driven engine accessory driven by said electric induction motor.

21. The system for driving electric induction motor engine accessories according to claim 20, wherein said electric motor driven engine accessories include at least one of a fuel pump, lube pump, and air pump.

22. A system for driving electric induction motor driven accessories, comprising:
a gas turbine engine rotating an input shaft of a permanent magnetic generator; and
a rotor structure and armature windings generating three-phase variable voltage/variable frequency ac electric current when said input shaft is rotated;
wherein a ratio of said variable voltage to said variable frequency is substantially constant; and
said ac electric current being carried to said electric induction motor driven accessories.

23. The system for driving electric motor driven accessories according to claim 22, wherein an engine output shaft of said gas turbine engine is formed integrally with said input shaft, thereby providing direct translation of rotation of said gas turbine engine with said input shaft of said permanent magnet generator.

24. The system for driving electric motor driven accessories according to claim 22, further comprising:
a variable voltage/variable frequency bus being energized with said electric current; and
at least one set of electrical conductors electrically connecting said variable voltage/variable frequency bus with said electric motor driven engine accessories.

25. The system for driving electric motor engine accessories according to claim 22, wherein said electric motor driven engine accessories include at least one of a fuel pump, a lube pump, and an air pump.
